(19) United States
(12) Patent Application Publication
(10) Pub. No.: US 2008/0156847 A1
(43) Pub. Date: Jul. 3, 2008

(54) Continuous motion spin welding apparatus, system, and method

(75) Inventors: Wesley Hawk, York, PA (US); Eric Gerhardt, York, PA (US); David Kohler, Perrysburg, OH (US)

Correspondence Address: MILES & STOCKBRIDGE PC, 1751 PINNACLE DRIVE, SUITE 500, MCLEAN, VA, 22102-3833, US

(73) Assignee: Graham Packaging Company, L.P., York, PA (US)

(21) Appl. No.: 11/648,560

(22) Filed: Jan. 3, 2007

(51) Int. Cl. B23K 20/12

(52) U.S. Cl. 228/112.1

(57) ABSTRACT

An apparatus, system, and method for friction (spin) welding separate parts of a plastic component to one another. The apparatus includes a rotational drive assembly coupled to a turret assembly arranged to be rotationally driven thereby about a longitudinal axis. The turret assembly includes at least one drive mechanism and a plurality of spindle assemblies disposed circumferentially around the longitudinal axis, each spindle assembly defining a spindle axis and including coupled to a chuck configured to receive and hold a first part of the plastic component. The chuck is configured to move along the respective spindle axis to contact the first part of the plastic component with a second part of the plastic component. The at least one drive mechanism is configured to move the chuck and the first part relative to the second part at a speed sufficient to permanently bond the first part to the second part during rotation of the turret assembly.

### BACKGROUND

1. Field of the Invention

The invention relates generally to an apparatus, system, and method for assembling separate plastic parts. More specifically, the invention relates to a continuous motion spin welding apparatus, system, and method for spin welding separate parts of a plastic container to one another.

2. Related Art

In one widely-used commercial type of liquid containing and dispensing package, a pouring spout fitment having an integrally formed axially protruding dispensing spout is fixedly positioned on the neck of a container. For example, U.S. Pat. No. 4,671,421 to Reiber et al., the entirety of which is incorporated herein by reference, shows a plastic liquid containing and dispensing package which comprises a plastic blow molded container having an annular finish, an insert pour spout fitment positioned in the finish and interengaged with the internal surface of the finish and fixed thereto as by spin welding.

Another example of this type of dispensing package is that disclosed in U.S. Pat. No. 5,462,202 to Haffner et al. (also incorporated herein by reference) which includes a liquid spout dispensing fitment for installation on a container neck and cooperable therewith to provide a drain back system (DBS) package. This fitment comprises a plastic body having an axial pour spout extending from within and protruding beyond the neck of the associated container. The fitment body has an outer annular apron wall spaced from the spout for catching spout spillage and for mounting the fitment on the container. An integral annular trench portion connects the spout and apron walls and provides a drain-back gutter.

The DBS pour spout fitment for such containers is typically initially made as a separate component from the container component and these separately-made components are then permanently assembled together by a liquid-tight joint, such as formed by an adhesive bond, solvent bond, sonic weld or a friction weld (commonly referred to as a spin weld). Spin welding has certain commonly recognized advantages over such other methods of permanent joinder such as: (a) lower cost, since no bonding material is required; (b) rapid cycle times for automated mass production, and (c) does not affect recycling concerns.

FIG. 1 is a diagrammatic view of a known spin welding station 200 as shown and disclosed, for example, in commonly-owned U.S. Pat. No. 5,941,422 to Struble, the entirety of which is hereby incorporated by reference. As indicated diagrammatically and schematically in FIG. 1, the spin welding station 200 includes a conventional spout fitment spinning fixture 210 that is operably coupled to a precision servo motor 211 that rotatably drives fixture 210 about the rotational axis 212, and that also positionally advances the fixture 210 along this axis 212 in a predetermined manner. Both of these motions are predetermined by an electronic control computer program provided in a conventional servo controller 213 operably electrically coupled to servo motor 211. For example, as indicated schematically in FIG. 1, fixture 210 may have suitable drive fingers 214 and 215. One or more of the shorter fingers 214 may circumferentially abut one or more associated drive lugs 221 provided on a fitment spout 220 to thereby impart rotational torque to fitment spout 220. Finger 215 may be elongated and adapted to register and drop through a drain back opening 222 in the spout fitment 220 as the fixture 210 is advanced axially downwardly into operable engagement with the loosely assembled spout fitment 220 on a container 230 in the welding station 200. Once finger 215 is so registered in opening 222, the angular orientation of the spout fitment 220 relative to an armature shaft of servo motor 211 is mechanically determined and then recorded and referenced as a known quantity by servo controller 213. Alternatively, as will be apparent to those skilled in the art, suitable conventional electro-optical digital pulse systems may be utilized in conjunction with the servo fixturing and control system to detect and register locate the salient spout fitment feature to be angularly oriented relative to the container body 230.

Spout fitment 220 is then rotated by the fixture 210 about axis 212, which is coincident with an axis defined by the container 230. At the same time, a slight downward axial pressure is exerted on the spout fitment 220 as container 230 is fixedly supported against the rotational and axial forces of the fixture 210, as indicated schematically by the support structure 240 in FIG. 1. This downward friction welding motion generates frictional heat between the spout fitment 220 and the container 230 sufficient to melt the plastic of one or both members and thereby bond them together. Frictional rubbing between the spout fitment 220 and the container 230 continues as spout fitment 220 is forced axially downwardly relative to the container 230 to a final fully assembled and welded position.

Known spin welding processes, thus, are performed by commercially available automated production equipment employing conventional fixturing for holding and rotating the spout fitment during spin welding as the container is supported stationarily. Such production equipment typically requires indexing of individual parts, station-to-station stop and go processing, and/or batch processing, any or all of which can limit processing speeds and increase costs. Furthermore, known spin welding devices often cannot accommodate containers of different sizes and/or can require significant change-over time for processing different size containers.

### SUMMARY

In view of the foregoing, the following example embodiments of the present invention are related to a continuous motion spin welding apparatus, system, and method for assembly fabrication of separate parts of a plastic component, for example, spin welding a pour spout fitment to a blow molded plastic container body.

In general, and by way of summary description and not by way of limitation, one embodiment of the invention includes an apparatus for friction welding separate parts of a plastic component to one another. The apparatus comprises a rotational drive assembly and a turret assembly coupled to the drive assembly. The turret assembly is arranged to be rotationally driven thereby about a longitudinal axis and includes at least one drive mechanism and a plurality of spindle assemblies disposed circumferentially around the longitudinal axis. Each spindle assembly defines a spindle axis and includes a chuck coupled to the at least one drive mechanism. The chuck is configured to receive and hold a first part of the plastic component and to move along the respective spindle axis to contact the first part of the plastic component with a second part of the plastic component. The at least one drive mechanism is configured to move the chuck and the first part relative to the second part at a speed sufficient to bond the first part to the second part. In one embodiment, the at least one drive mechanism is configured to rotate the chuck and the first part relative to the second part at a rotational speed sufficient to bond the first part to the second part. In another embodiment, the rotational drive assembly of the apparatus is configured to continuously drive the turret assembly during operation of the apparatus

In yet another embodiment, a system for friction welding separate parts of a plastic component to one another is described. The system comprises the above-described apparatus and further includes a rotary infeed starwheel spindle and a rotary exit starwheel spindle assembly assembly, both arranged adjacent to the turret assembly. The rotary infeed starwheel spindle assembly is configured to receive the first and second parts of the plastic component and to transfer the first and second parts to the turret assembly. The rotary exit starwheel spindle assembly is configured to receive an integral finished product from the turret assembly. The system further comprises a first part feeder assembly and a second part feeder assembly, both arranged adjacent to the rotary infeed starwheel spindle assembly. The first part feeder assembly is configured to supply the first part to the rotary infeed starwheel spindle assembly. The second part feeder assembly is configured to supply the second part to the rotary infeed starwheel spindle assembly.

In yet another embodiment of the invention, a method of friction welding separate parts of a plastic component to one another with the above-described apparatus is disclosed. The method comprises the steps of rotating the turret assembly about the longitudinal axis, supplying a first part to one of the spindle assemblies on the turret assembly, supplying a second part to the turret assembly, moving the chuck of the spindle assembly along the respective spindle axis, engaging the first part with the chuck, contacting the first part of the plastic component with a second part of the plastic component, and moving the chuck and the first part relative to the second part at a speed sufficient to bond the first part to the second part. In one embodiment, the step of moving the chuck and the first part relative to the second part at a speed sufficient to bond the first part to the second part includes rotating the chuck and the first part relative to the second part at a rotational speed sufficient to bond the first part to the second part. In another embodiment, the step of rotating the turret assembly about the longitudinal axis may comprise continuously rotating the turret assembly about the longitudinal axis

### BRIEF DESCRIPTION OF THE DRAWINGS

The foregoing and other features and advantages of the invention will be apparent from the following, more particular description of the embodiments of the invention, as illustrated in the accompanying drawings.

FIG. 1 is a diagrammatic view of a known spin welding station;

FIG. 2 is a diagrammatic plan view of a continuous motion spin welding system and apparatus according to one embodiment of the invention; and

FIG. 3 is a diagrammatic plan view of the continuous motion spin welding system and apparatus of FIG. 2 depicting an exemplary path of a container during operation;

FIG. 4 is a diagrammatic front view of the continuous motion spin welding apparatus according to one embodiment of the invention;

FIG. 5 is a diagrammatic side view of the continuous motion spin welding apparatus of FIG. 4;

FIGS. 6A and 6B are diagrammatic views of the vertical position of the spindle assembly chuck of the continuous motion spin welding apparatus of FIG. 4 relative to the vertical position of a respective spout and a “maximum up” position as a function of the rotational position of the turret assembly during operation;

FIG. 7 is a chart depicting the timing (initiation, duration, and termination) of specific events as a function of the rotational position of the turret assembly according to an example embodiment of the invention; and

FIG. 8 is a diagrammatic top view of a portion of a container clamp mechanism according to one embodiment of the continuous motion spin welding apparatus of FIGS. 4 and 5.

### DETAILED DESCRIPTION

In describing the example embodiments of the present invention illustrated in the drawings, specific terminology is employed for the sake of clarity. However, the invention is not intended to be limited to the specific terminology so selected. It is to be understood that each specific element includes all technical equivalents that operate in a similar manner to accomplish a similar purpose. While specific exemplary embodiments are discussed, it should be understood that this is done for illustration purposes only. A person skilled in the relevant art will recognize that other components and configurations can be used without parting from the spirit and scope of the invention. Each patent document and/or non-patent literature publication cited herein is incorporated by reference in its entirety.

The invention relates to an apparatus and method for assembling separate plastic container parts. More specifically, the invention relates to a continuous motion spin welding apparatus, system, and method for spin welding separate plastic container parts to one another, for example a spout S and a container C.

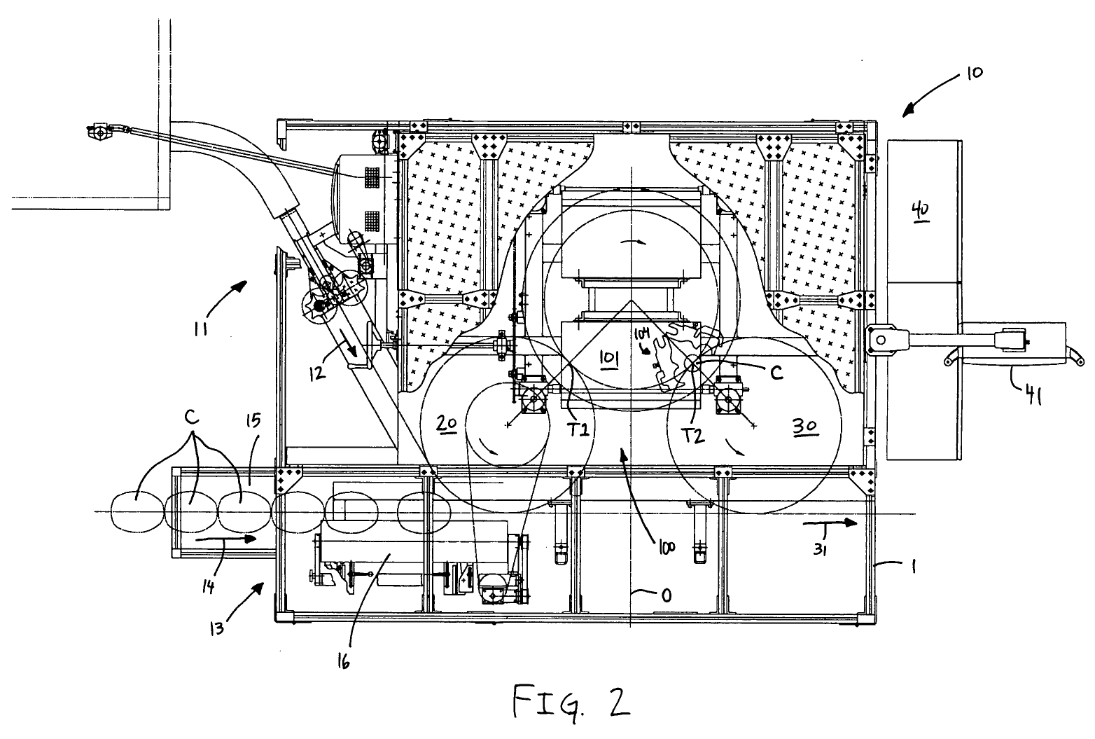

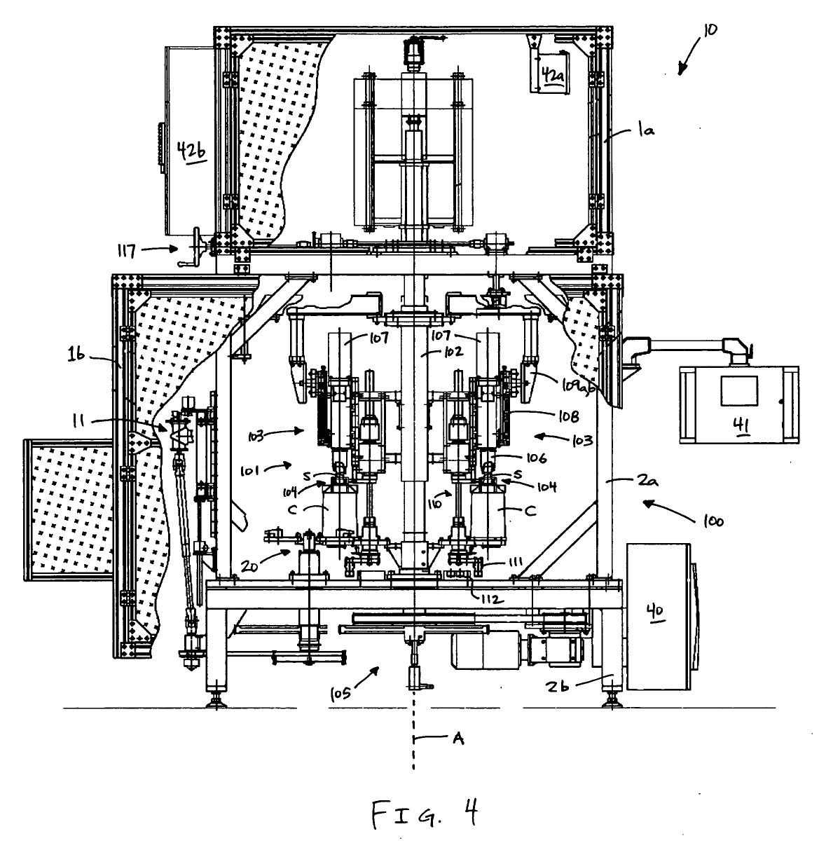

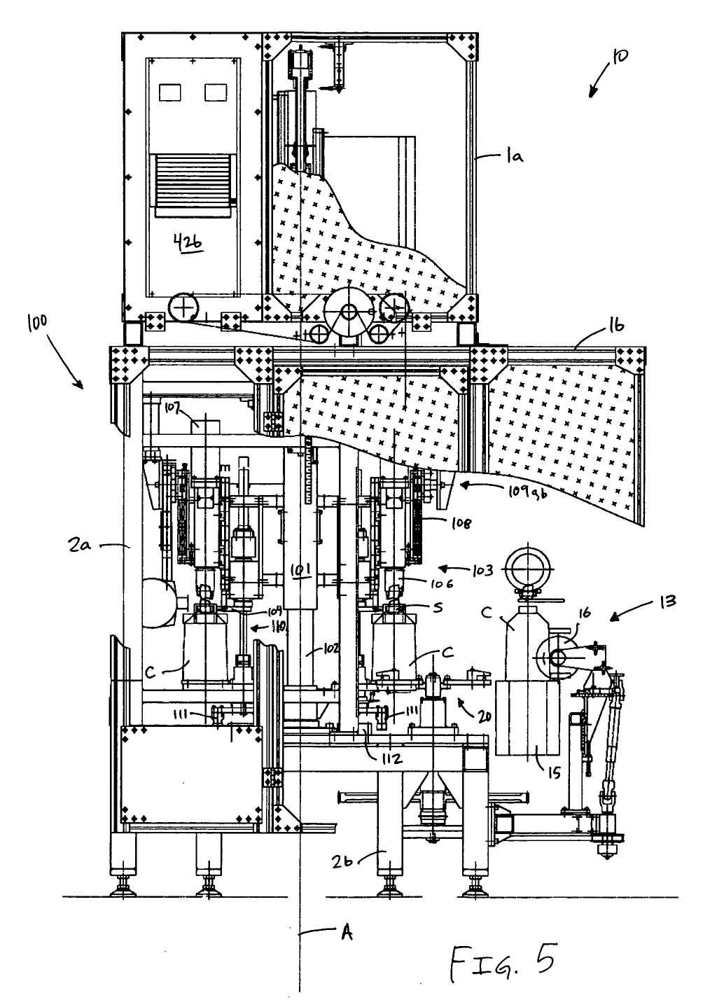

FIG. 2 is a diagrammatic plan view of a continuous motion spin welding system 10 according to one embodiment of the invention. Referring to FIG. 2, the continuous motion spin welding system 10 broadly includes a spout feeder assembly 11, a container feeder assembly 13, and a continuous motion spin welder apparatus 100 having a rotary infeed starwheel spindle assembly 20, a rotary turret assembly 101, and a rotary outfeed starwheel spindle assembly 30. At least some of the continuous motion spin welding system 10 is disposed within a guard assembly I and supported by a frame assembly 2 (see FIGS. 4 and 5). The spout feeder assembly 11 is arranged to feed spouts S in the direction of arrow 12 to a rotary infeed starwheel spindle assembly 20. Likewise, the container feeder assembly 13 is arranged to feed containers C in the direction of arrow 14 to the rotary infeed starwheel spindle assembly 20. The spout feeder assembly 11 and container feeder assembly 13 are mechanically and/or electronically coupled to the rotary infeed starwheel spindle assembly 20 and/or to each other such that the operational timing of each assembly is synchronized. Each spout S received on the rotary infeed starwheel spindle assembly 20 is aligned with a respective container C received thereon.

The rotary infeed starwheel spindle assembly 20 is arranged adjacent to the rotary turret assembly 101 of the continuous motion spin welder apparatus 100 such that spouts S and containers C received on the rotary infeed starwheel spindle assembly 20 can be readily transferred at point T1 to a peripheral position on the turret assembly 101. As can be seen in the embodiment depicted in FIG. 2, the rotary infeed starwheel spindle assembly 20 rotates counterclockwise when viewed from above (see arrow). Conversely, the turret assembly 101 rotates clockwise when viewed from above (see arrow). The rotary infeed starwheel spindle assembly 20 and the rotary turret assembly 101 have substantially identical tangential speeds at point T1 in order to facilitate the transfer of spouts S and containers C therebetween.

The rotary turret assembly 101 includes a plurality of clamping mechanisms 104, for example six clamping mechanisms 104, circumferentially spaced around the outer periphery thereof and arranged to receive and hold the containers C transferred from the rotary infeed starwheel spindle assembly 20 at point T1. The turret assembly 101 also includes a plurality of spindle assemblies 103, for example six spindle assemblies 103, circumferentially spaced around the outer periphery of the rotary turret assembly 101 adjacent to each of the plurality of clamping mechanisms 104 and arranged to receive and hold the spouts S transferred from the rotary infeed starwheel spindle assembly 20 at point T1 (see FIGS. 4-6—described in further detail below). During rotation of the turret assembly 101, the spindle assemblies 103 spin weld each respective spout S with each respective container C to form an integral finished product. In this way, a respective spout S and container C are placed in contact with, and spin welded to, one another while concurrently moving along a continuous path.

The turret assembly 101 is also arranged adjacent to a rotary exit starwheel spindle assembly 30 such that each finished integral product having a spout S and a container C can be readily transferred at point T2 to a peripheral position on the rotary exit starwheel spindle assembly 30. As can be seen in the embodiment depicted in FIG. 2, the turret assembly 101 rotates clockwise when viewed from above (see arrow). Conversely, the rotary exit starwheel spindle assembly 30 rotates counterclockwise when viewed from above (see arrow). The rotary exit starwheel spindle assembly 30 and the turret assembly have substantially identical tangential speeds at point T2 in order to facilitate the transfer of the integral finished product therebetween. Each integral finished product is received by the rotary exit starwheel spindle assembly 30 and then advanced in a direction away from the continuous motion spin welding system 10 as indicated by arrow 31.

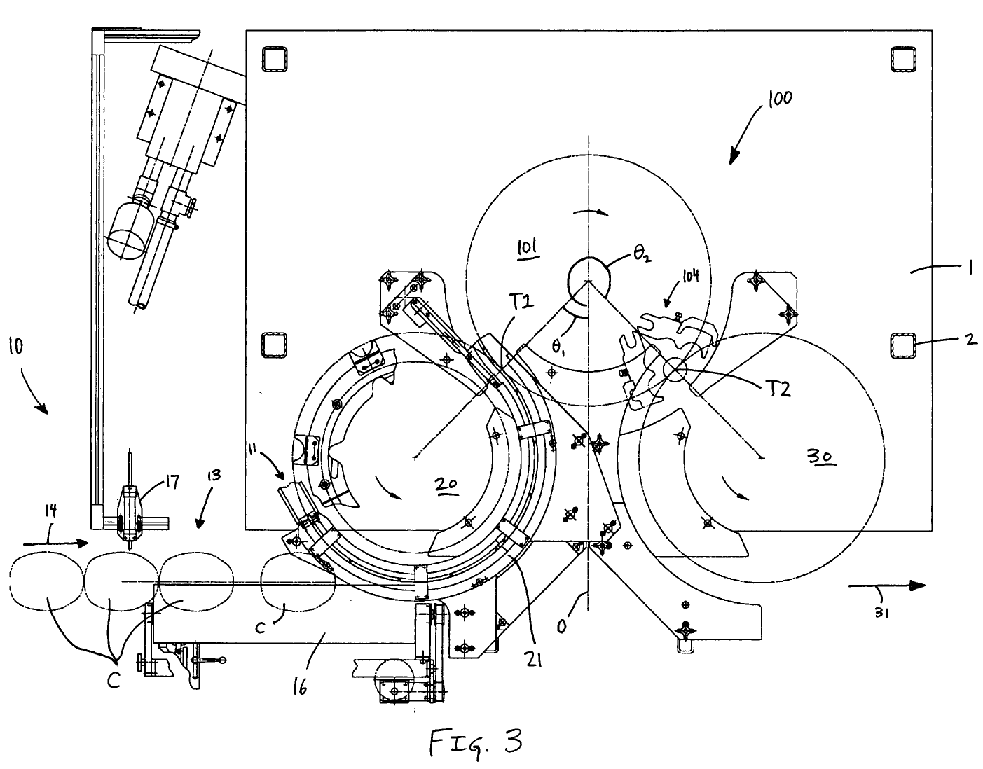

FIG. 3 is a diagrammatic plan view of the continuous motion spin welding system 10 and apparatus 100 of FIG. 2 depicting an exemplary path of a container C during operation. Containers C are advanced on the container feeder assembly 13 in the direction indicated by arrow 14. The container feeder assembly 13 includes a conveyor 15 (see FIG. 2), a container feed timing screw 16, and a container ejection device 17. The spout feeder assembly 11 may include elements substantially similar to those described for the container feeder assembly 13 and is not described further herein. A container gate (not shown) controls the flow of container C into a container infeed starwheel assembly portion of the rotary infeed starwheel spindle assembly 20. Each container C is fed from the conveyor 15 to the container feed timing screw 16, which continues to advance each container C in the direction indicated by arrow 14 to a respective peripheral recess (not shown in detail) in the container infeed starwheel assembly portion of the rotary infeed starwheel spindle assembly 20. Each container C is then carried in a counterclockwise direction by the container infeed starwheel assembly portion of the rotary infeed starwheel spindle assembly 20 beneath a spout table 21. At point T1, each container C is transferred to a peripheral position on the turret assembly and gripped securely by clamp mechanism 104. Each container C is then rotated clockwise between points T1 and T2, during which time a respective spout S is contacted to the neck of the container C and spin welded thereto by a respective one of the spindle assemblies 103 (see FIGS. 4-6—described in further detail below) to form an integral final product. At point T2, each container C is released by the clamp mechanism 104 and thereby transferred to a respective peripheral recess (not shown in detail) in a container exit starwheel assembly portion of the rotary exit starwheel spindle assembly 30. Each container C is then carried in a counterclockwise direction by the container exit starwheel assembly portion of the rotary exit starwheel spindle assembly 30 until it can be released in a direction indicated by arrow 31 for further processing, e.g. filling, labeling, and/or packaging.

FIG. 4 is a diagrammatic front view of the continuous motion spin welding apparatus 100 of the system 10 according to one embodiment of the invention. FIG. 5 is a diagrammatic side view of the continuous motion spin welding apparatus 100 of FIG. 4. With reference to FIGS. 4 and 5, the apparatus 100 is supported upon upper and lower base frames 2a, 2b and may be substantially enclosed within upper and lower guard assemblies 1a, 1b for safety purposes. The apparatus 100 includes the rotary turret assembly 101 which has a turret shaft 102. The apparatus 100 further includes a base drive assembly 105 arranged to provide rotational power to the turret shaft 102. The base drive assembly 105 also provides synchronized driving power to other system elements including the spout feeder assembly 11, the container feeder assembly 13, the rotary infeed starwheel spindle assembly 20, and the rotary exit starwheel spindle assembly 30 via respective gear trains (not shown in detail) such that the operational timing of the various system elements is synchronized.

Still referring to FIGS. 4 and 5, the turret assembly 101, and in particular, the turret shaft 102, define a central longitudinal axis A about which the turret assembly 101 rotates when driven by the base drive assembly 105. The turret assembly 101 also includes at least one drive mechanism 107 and a plurality of spindle assemblies 103 circumferentially disposed around the longitudinal axis A. The at least one drive mechanism 107 may include, for example, one or more servomotors, one or more air motors, one or more planetary gear systems, one or more separately driven timing belts, or some other like mechanical or electro-mechanical driving mechanism operatively coupled to one or more spindle assemblies 103. In one embodiment, each spindle assembly 103 is mounted to the turret shaft 102 at a radially outward position and the at least one drive mechanism 107 is a servomotor. Each spindle assembly 103 may include a chuck 106 for receiving, holding, and rotating the spout S, a servomotor 107 for rotatably driving the chuck 106 to spin weld a spout S to a container C, and a cam follower assembly 108 arranged to be guided by upper and lower spindle cams 109a, 109b for determining the relative vertical position of each spindle assembly 103 as the turret assembly 101 rotates about axis A. Upper and lower spindle cams 109a, 109b are arranged to effectively provide a mechanical track upon which the spindle cam follower assembly 108 can ride and thereby vary the relative vertical position of each spindle assembly 103 as the turret assembly 101 rotates during operation. Upper and lower spindle cams 109a, 109b are adjustably supported from a top portion of upper base frame 2a so as to allow easy adjustment (see handwheel 117) for changes in the height of the container C to be processed in apparatus 100. Alternatively, one or more servomotors and/or a hydraulic or pneumatic system could be employed on each spindle assembly 103 in place of the cam follower assembly 108 and upper and lower cams 109a, 109b to provide other electromechanical and mechanical solutions for varying the relative vertical position of the spindle assembly 103 as the turret assembly 101 rotates.

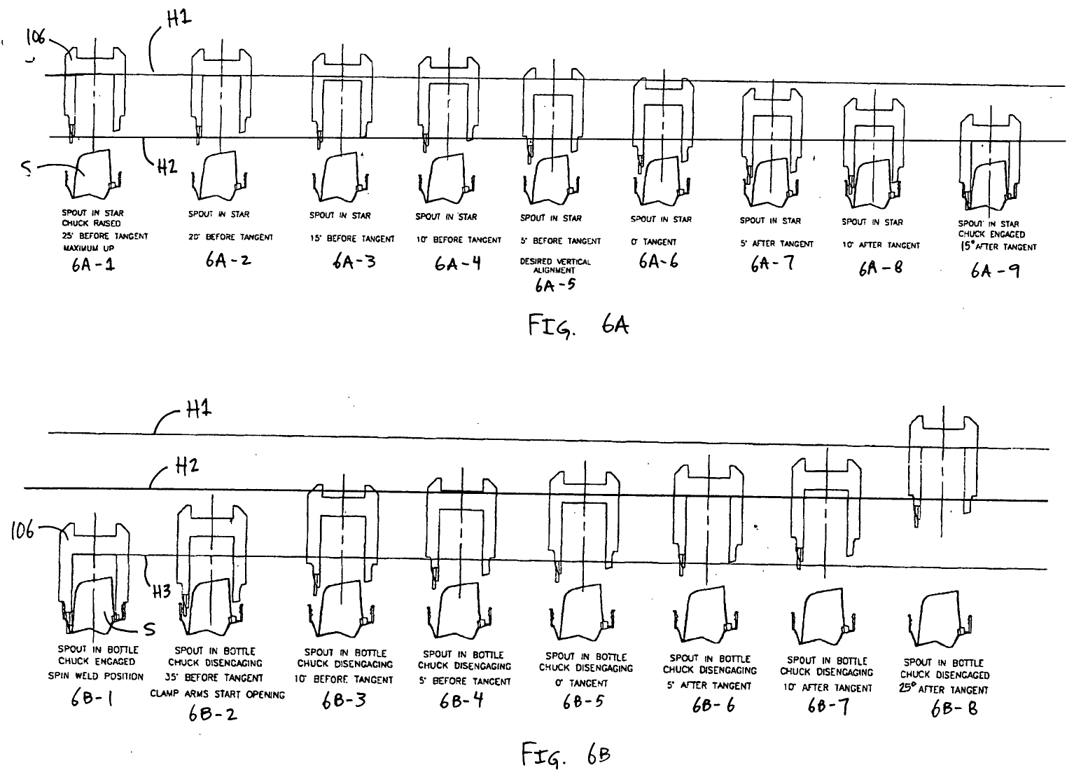

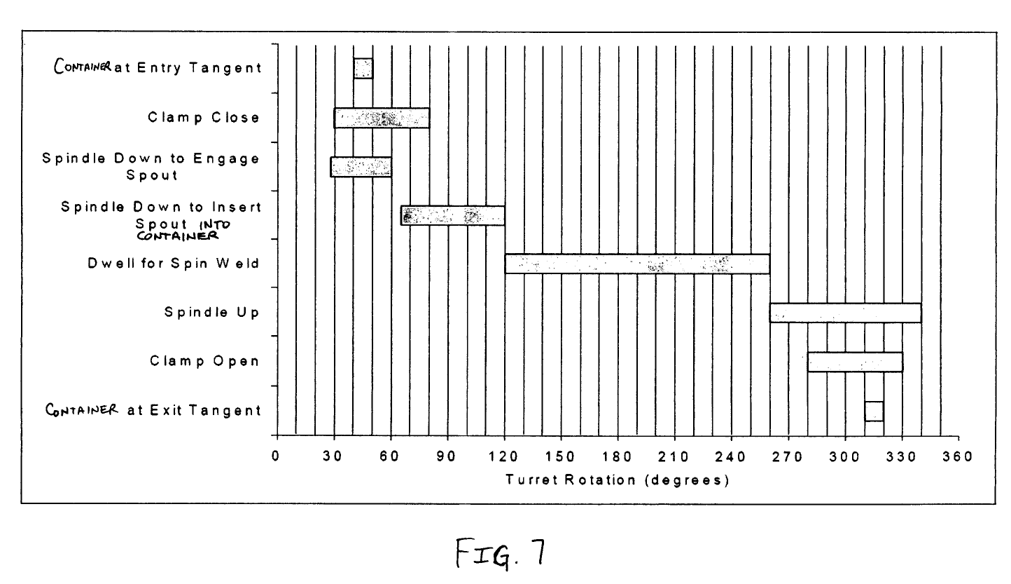

In the example embodiment, each chuck 106 of the plurality of spindle assemblies 103 is configured to receive, orient, hold, and rotate a spout S received thereon at point TI from the rotary infeed starwheel spindle assembly 20. The chuck 106 may be a conventional chuck fixture as described, for example, in U.S. Pat. No. 5,941,422, which is incorporated herein by reference in its entirety. A servomotor 107 is operatively coupled to each respective chuck 106 and is configured to rotate the chuck 106 for a predetermined time at a speed (in Revolutions Per Minute—RPM) sufficient to heat the plastic of the respective spout S and container C and thereby weld them together. The predetermined time and rotational speed sufficient to weld the spout S and container C together depends on various process variables including, for example, material type, weld diameter, and interference fit and will be apparent to one of ordinary skill in the art. The servomotors 107 may be adjustably programmed to have a speed-time motion profile, whereby during rotation of the turret assembly 101 and after receiving, gripping, and inserting a spout S into a container C, each respective servomotor 107 initiates rotation of chuck 106, accelerates chuck 106 to a predetermined maximum speed, maintains such maximum speed for a predetermined period of time, and then decelerates chuck 106 until chuck 106 is stopped. Alternatively, the servomotors 107 may be adjustably programmed to have a speed-time motion profile, whereby during rotation of the turret assembly 101 and after receiving, gripping, and inserting a spout S into a container C, each respective servomotor 107 initiates rotation of chuck 106, accelerates chuck 106 at to a predetermined maximum speed, and then, once such predetermined maximum speed is achieved, decelerates chuck 106 until chuck 106 is stopped. Other speed-time motion profiles are also possible. Also, in another embodiment of the invention, the drive mechanism (servomotor) 107 may move the chuck 106 in a manner other than rotation yet sufficient to heat the plastic of the respective spout S and container C and thereby weld them together such as, for example, reciprocating or vibrational movement. Details of the vertical position of the spindle assembly 103, specifically chuck 106, relative to the spout S (i.e, a delivery height of spout S) and container C as a function of the rotational position of the turret assembly 101 are further described below with reference to FIGS. 6A, 6B, and 7.

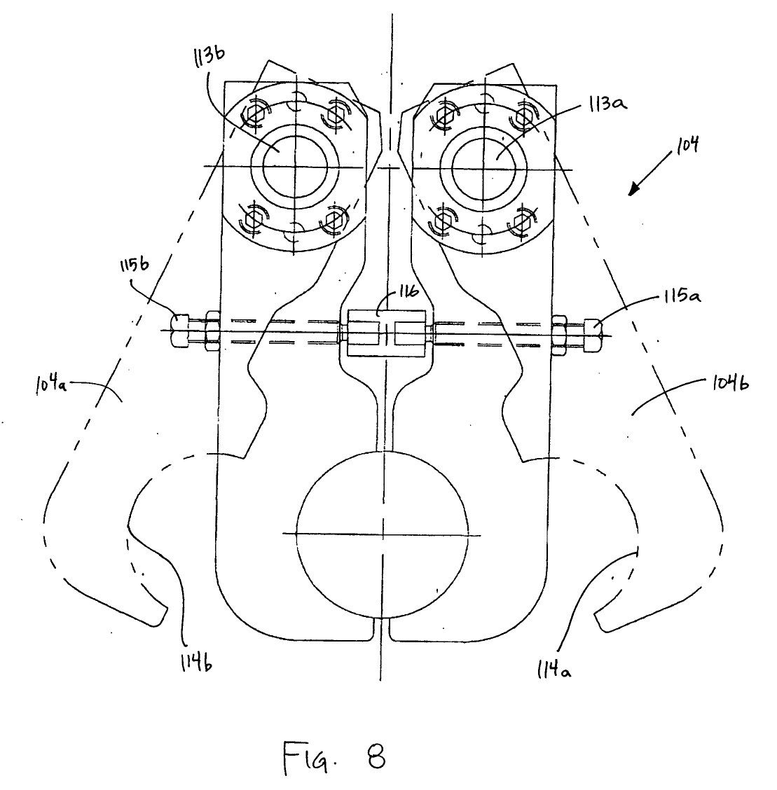

Still referring to FIGS. 4 and 5, the turret assembly 101 further includes a plurality of clamping mechanisms 104 circumferentially spaced around the outer periphery of the turret assembly 101 adjacent to each of the plurality of spindle assemblies 103 and arranged to receive and hold the containers C transferred from the rotary infeed starwheel spindle assembly 20 at point Ti. In one embodiment, the plurality of clamping mechanisms 104 is six clamping mechanisms. FIG. 8 is a diagrammatic top view of a portion of a container clamp mechanism 104 according to one embodiment of the continuous motion spin welding apparatus 100 of FIGS. 4 and 5. As shown in the embodiment depicted in FIG. 8, each clamp mechanism 104 includes a first clamp arm 104a pivotably attached to shaft 113a and a second clamp arm 104b pivotably attached to shaft 113b. The clamp arms 104a, 104b are arranged to move between a first open (receiving) position wherein the clamp arms 104a, 104b can receive a component such as a container C, and a second closed (clamping) position wherein respective gripping portions 114a, 114b of clamp arms 104a, 104b grip a container C received by clamping mechanism 104. Adjustable clamp arm stop screws 115a, 115b may be included on each clamp arm 104a, 104b of the clamping mechanism 104 to allow easy adjustment of the relative position of each clamp arm 104a, 104b in the second closed position such that different size containers C can be received and held therein. A stop bar 116 may be disposed between the clamp arms 104a, 104b. In the second closed position, clamp arm stop screws 115a, 115b contact the stop bar 116 which serves to prevent further movement of the clamp arms 104a, 104b towards one another. In another embodiment, the clamping mechanism 104 may not include adjustable clamp arm stop screws 115a, 115b or stop bar 116, in which case the stop position of clamp arms 104a, 104b in the second closed position may not be repetitively accurate.

Referring again to FIGS. 4 and 5, each clamping mechanism 104 is attached to a respective crank mechanism 110 which is arranged to determine the clamping motion of the clamp arms 104a, 104b as a function of the rotational position of the turret assembly 101. Each crank mechanism 110 includes a respective cam roller 111 positioned to be guided by a clamp arm cam 112. Clamp arm cam 112 is arranged to effectively provide a mechanical track upon which the cam roller 111 can ride and thereby vary the position of each clamp arm 104a, 104b of each clamping mechanism 104 as the turret assembly 101 rotates during operation. Alternatively, one or more servomotors and/or a hydraulic or pneumatic system could be operatively coupled to each clamping mechanism 104 in place of the crank mechanism 110, including cam roller 111 and clamp arm cam 112, to provide other electro-mechanical and mechanical solutions for varying the relative position of each clamping mechanism 104 as the turret assembly 101 rotates.

FIGS. 6A and 6B are diagrammatic views of the vertical position of the spindle assembly chuck 106 in an example embodiment of the continuous motion spin welding apparatus 100 relative to the vertical position of a respective spout S (i.e, a delivery height of spout S) as measured from a “maximum up” position as a function of the rotational position of the turret assembly 101 during operation. As noted above, the turret assembly 101 rotates clockwise when viewed from above. With reference to FIGS. 2 and 3, the zero point (denoted by reference numeral 0) of the 360 degrees of turret rotation is located mid-way between the infeed and outfeed star wheels 20, 30. The infeed tangent point T1, i.e., the point at which spouts S and containers C are transferred from the rotary infeed starwheel spindle assembly 20 to the turret assembly 101 lies at approximately 45 degrees (clockwise) from the zero point 0 as indicated by θ₁. The exit tangent point T2, i.e., the point at which the integral finished products comprised of spouts S and containers C are transferred from turret assembly 101 to the rotary exit starwheel spindle assembly 30 lies at approximately 315 degrees (clockwise) from the zero point 0 as indicated by θ₂. While specific exemplary embodiments are discussed, it should be understood that this is done for illustration purposes only. A person skilled in the relevant art will recognize that other configurations can be used without parting from the spirit and scope of the invention.

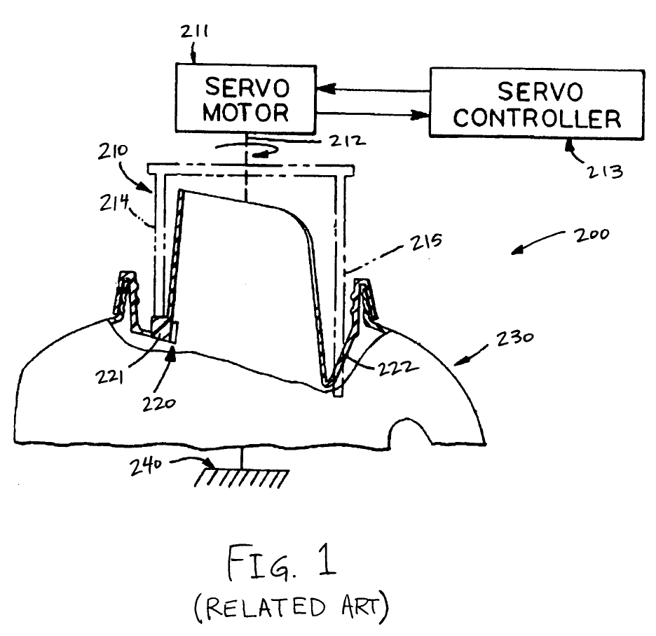

With the foregoing reference points and positions in mind, reference is now made to FIG. 6A. In sub-FIG. 6A-1, a respective one of the plurality of chucks 106 positioned around the periphery of the turret assembly 101 is shown at a “maximum up” vertical position H1. At this time, the spout S is disposed on the rotary infeed starwheel spindle assembly 20 and the chuck 106 is rotationally positioned at 25 degrees before tangent point T1. Also at this time, clamp arms 104a, 104b of clamping mechanism 104 are open to receive a container C but are moving towards the second closed position (see FIG. 8). In sub-FIG. 6A-2, the chuck 106 is still at vertical position H1, 20 degrees before tangent point T1; spout S is rotationally advancing toward tangent point T1 in starwheel assembly 20. In sub-FIG. 6A-3, chuck 106 is moving vertically downward from position H1 towards position H2, 15 degrees before tangent point T1; spout S is rotationally advancing toward tangent point T1 in starwheel assembly 20. In sub-FIG. 6A-4, chuck 106 is moving vertically downward from position H1 towards position H2, 10 degrees before tangent point T1; spout S is rotationally advancing toward tangent point T1 in starwheel assembly 20. In sub-FIG. 6A-5, chuck 106 is moving vertically downward from position H1 towards position H2, 5 degrees before tangent point T1; spout S is rotationally advancing toward tangent point T1 in starwheel assembly 20. In sub-FIG. 6A-6, chuck 106 is moving vertically downward from position H1 towards position H2 and is at tangent point T1; spout S is at tangent point T1 in starwheel assembly 20. In sub-FIG. 6A-7, chuck 106 is moving vertically downward from position H1 towards position H2, 5 degrees after tangent point T1; spout S is advancing rotationally just past tangent point T1 on spout table 21. In sub-FIG. 6A-8, chuck 106 is moving vertically downward from position H1 towards position H2, 10 degrees after tangent point T1; spout S is advancing rotationally away from tangent point T1 on spout table 21. In sub-FIG. 6A-9, chuck 106 is at vertical position H2, 15 degrees after tangent point T1; spout S is engaged and held by chuck 106. Between the angles of 65 and 120 degrees of turret rotation (clockwise), the chuck 106 is advanced further vertically downward to position H3 to insert spout S into an aligned container C (see FIG. 6B-sub-FIG. 6B-1). Between the angles of 120 and 260 degrees of turret rotation, the chuck 106 is rotated at a high speed to spin weld the spout S to the container C (see FIG. 6B-sub-FIG. 6B-1).

With reference to FIG. 6B, as noted above sub-FIG. 6B-1 shows chuck 106 at vertical position H3 between the angles of 120 and 260 degrees of turret rotation; spout S is inserted within and spin welded to container C. In sub-FIG. 6B-2, chuck 106 is moving vertically upward from position H3 towards position H1, 35 degrees before exit tangent point T2; spout S and container C are permanently connected to one another and form an integral finished product. In sub-FIGS. 6B-3 and 6B-4, chuck 106 is moving vertically upward from position H3 towards position H1, 10 degrees and 5 degrees before exit tangent point T2, respectively. In sub-FIG. 6B-5, chuck 106 is still moving vertically upward from position H3 towards position H1, and is positioned at exit tangent point T2; the integral finished product is transferred from the turret assembly 101 to the rotary exit starwheel spindle assembly 30. In sub-FIG. 6B-6 and 6B-7, chuck 106 is moving vertically upward towards position H1, 5 degrees and 10 degrees after exit tangent point T2, respectively. In sub-FIG. 6B-8, chuck 106 is at position H1, 25 degrees after exit tangent point T2 (i.e., 20 degrees before the respective chuck 106 returns to the zero point 0).

The chart presented in FIG. 7 also graphically depicts the timing (initiation, duration, and termination) of specific events as a function of the rotational position of the turret assembly 101 according to an example embodiment of the invention. With reference to FIG. 7, containers C are received by clamp arms 104a, 104b on the turret assembly 101 from the rotary infeed starwheel spindle assembly 20 at 45 degrees of turret rotation (measured clockwise from the zero point 0). The closing motion of the clamp arms 104a, 104b begins at 30 degrees of turret rotation and ends at 80 degrees of turret rotation. At 45 degrees of turret rotation (point T1), the spout S transfers from following the rotary motion of the rotary infeed starwheel spindle assembly 20 to following the rotary motion of the turret assembly 101 due to stationary fences (not shown) on spout table 21 that define a spout path. The rotary infeed starwheel spindle assembly 20 keeps the spout S in motion while the chuck 106 lowers to engage the spout S. In one embodiment, the chuck 106 moves down approximately 2.625″ from a “maximum up” position H1 to engage the spout S at position H2 as the turret assembly 101 rotates. This movement of the chuck 106 between vertical positions H1 and H2 occurs between 28 and 60 degrees of turret rotation. At vertical position H2, the chuck 106 momentarily dwells before continuing down approximately 2.375″ in one embodiment to vertical position H3 to insert the spout S into the container C. In one embodiment, the dwell occurs, for example, from 60 to 65 degrees of turret rotation and the 2.375″ insertion move occurs from 65 to 120 degrees of turret rotation. Between 120 and 260 degrees of turret rotation, the chuck 106 dwells at a constant elevation H3 while the chuck 106 rotates the spout S at high speed to spin weld the spout S to the container C. After the spin welding operation is complete, the chuck 106 moves up approximately 5.000″ from vertical position H3 to “maximum up” vertical position H1 between the angles of 260 to 340 degrees of turret rotation as the clamp arms 104a, 104b release the integral finished product. In one embodiment, the clamp open movement occurs between the angles of 280 to 330 degrees of turret rotation, releasing the integral finished product to the rotary exit starwheel spindle assembly 30 to be transported away from the apparatus 100 for further processing.

With regard to the above-described embodiments of the operation of apparatus 100, it is noted that various process variables, for example, the rotational speed of the turret assembly 101, the relative rotational position of the turret assembly at which specific events are initiated and/or terminated, or the rotational speed of the chuck 106 for welding, may be adjusted in order to vary the number of containers C processed per minute or to change weld characteristics. Moreover, the process variables may be adjusted depending on the type of material of the parts of the plastic component, the weld diameter, and/or the interference fit between the first and second parts. Specific events, such as clamp arms 104a, 104b closing and opening may be arranged to happen at specific points of turret rotation, as shown for example in FIG. 7, to minimize acceleration (G forces) and vibration of machine components. These and other system processing values, however, such as speeds, positions, and distances, may also be adjustable within system confines based on processing requirements.

The above-described system 10 and apparatus 100 are substantially automated. The various system elements are linked to a common electronic control system which receives data therefrom and provides electronic feedback as necessary. As shown in FIG. 4, an operator control station interface, for example a touchscreen monitor 41 (HMI—Human-Machine Interface) is attached to an outside of the lower guard assembly 1b for access by an operator to view and control the system 10 and apparatus 100. A main control electronics enclosure 40 is also attached to the lower base frame 2b and includes the system control electronics therein including, for example, a Programmable Logic Controller (PLC). Other electronic consoles, for example, “servo drive” and “servo control” cabinets 42a, 42b are shown as being attached to the upper guard assembly 1a.

In one embodiment, the system's controls use information from encoders (electronic devices that measures the angle of a rotating shaft) to monitor and control motor speed and position, turret position, chuck position, etc. In one embodiment, there may be up to nine or more encoders on the system 10, e.g., six encoders embedded inside the six spindle assembly servomotors 107, one encoder embedded inside a spout metering starwheel servomotor, and an encoder mounted externally to each of the main turret shaft 102 and the spout infeed worm screw.

Within the system 10, various other sensors may also be employed to assist in synchronizing the various system components during start-up and operation, especially to ensure product quality and prevent part jams that may damage the system components. In one or more embodiments of the invention, example sensors may include a “spouts low” photo cell sensor, a “spouts high” photo cell sensor, a “containers low” photo cell sensor, a “containers high” photo cell sensor, an “idle spout” photo cell sensor to detect spouts that did not weld properly to a respective container, a finished product count photo cell sensor, a finished product backlog photo cell sensor, and upper and lower finished product inspection photo cell sensors. The relative positions of each of the recited sensors within the system will be apparent to one having ordinary skill in the art. Various system elements, for example the rotary infeed and exit starwheel spindle assemblies, may also include safety clutch proximity switches to detect component jams and, accordingly, shut down operation of the system until the problem component can be removed.

The system 10 may also include a compressor or a compressed air supply to be used in various elements in the system.

The examples and embodiments described herein are non-limiting examples. Although the system and apparatus are described above with reference to the connection of spouts S and containers C, one of ordinary skill will recognize that the system and apparatus may be applicable to the connection of various other separate parts to form an integral final plastic component. In some embodiments, the apparatus, system, and method may be automatically operable at high speed mass production rates to accurately orient the pour spout fitment as required with respect to the container configuration features, e.g., pour spout lip diametrically opposite container handle, and ensure a consistent and controlled placement of the fitment part to the container in final permanently joined and sealed condition.

The invention is described in detail with respect to one or more example embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed as new and desired to be protected by Letters Patent of the United States is:

1. An apparatus for friction welding separate parts of a plastic component to one another, the apparatus comprising:
a rotational drive assembly; and
a turret assembly coupled to the rotational drive assembly and arranged to be rotationally driven thereby about a longitudinal axis, the turret assembly including:
at least one drive mechanism; and
a plurality of spindle assemblies disposed circumferentially around the longitudinal axis, each spindle assembly defining a spindle axis and including:
a chuck coupled to the at least one drive mechanism and configured to receive and hold a first part of the plastic component, wherein the chuck is configured to move along the respective spindle axis to contact the first part of the plastic component with a second part of the plastic component, and wherein the at least one drive mechanism is configured to move the chuck and the first part relative to the second part at a speed sufficient to permanently bond the first part to the second part.

2. The apparatus according to claim 1, wherein the at least one drive mechanism is configured to rotate the chuck and the first part relative to the second part at a rotational speed sufficient to permanently bond the first part to the second part.

3. The apparatus according to claim 1, wherein the turret assembly further comprises a turret shaft extending along the longitudinal axis.

4. The apparatus according to claim 1, wherein each spindle assembly defines a spindle axis extending substantially parallel to the longitudinal axis.

5. The apparatus according to claim 1, wherein each spindle assembly defines a spindle axis and is configured to move along the spindle axis during rotation of the turret assembly.

6. The apparatus according to claim 5, wherein each of the plurality of spindle assemblies further comprises a cam follower assembly arranged to be guided by upper and lower spindle cams to determine movement of each spindle assembly along the spindle axis during rotation of the turret assembly.

7. The apparatus according to claim 6, wherein the upper and lower spindle cams are adjustably supported on a frame assembly of the apparatus.

8. The apparatus according to claim 1, wherein the turret assembly further comprises a plurality of clamping mechanisms disposed circumferentially around the longitudinal axis adjacent to a respective one of the spindle assemblies, each clamping mechanism arranged to receive and hold the second part of the plastic component.

9. The apparatus according to claim 8, wherein each of the plurality of clamping mechanisms includes a first clamp arm and a second clamp arm, the first and second clamp arms arranged to move between a first open position to receive the second part of the plastic component and a second closed position to hold the second part of the plastic component.

10. The apparatus according to claim 9, wherein each of the first and second arms of the plurality of clamping mechanisms further includes an adjustable stop screw arranged to contact a stop bar.

11. The apparatus according to claim 8, wherein the turret assembly further comprises a plurality of crank mechanisms operatively coupled to each of the plurality of clamping mechanisms, each of the plurality of crank mechanisms having a cam roller arranged to be guided by a clamp arm cam to determine the position of the clamp arms as a function of a rotational angle of the turret assembly.

12. The apparatus according to claim 1, further comprising a rotary infeed starwheel spindle assembly arranged adjacent to the turret assembly, wherein the rotary infeed starwheel spindle assembly is configured to receive the first and second parts of the plastic component and to transfer the first and second parts to the turret assembly.

13. The apparatus according to claim 1, further comprising a rotary exit starwheel spindle assembly arranged adjacent to the turret assembly, wherein the rotary exit starwheel spindle assembly is configured to receive an integral finished product from the turret assembly.

14. The apparatus of claim 1, wherein the first part is a plastic spout and the second part is a plastic container.

15. The apparatus of claim 1, wherein the rotational drive assembly is configured to continuously rotate the turret assembly during operation of the apparatus.

16. The apparatus of claim 1, wherein the at least one drive mechanism is a servomotor.

17. The apparatus of claim 1, wherein each spindle assembly includes one of the at least one drive mechanisms.

18. A system for friction welding separate parts of a plastic component to one another, the system comprising:
the apparatus of claim 1 further comprising:
a rotary infeed starwheel spindle assembly arranged adjacent to the turret assembly, wherein the rotary infeed starwheel spindle assembly is configured to receive the first and second parts of the plastic component and to transfer the first and second parts to the turret assembly; and
a rotary exit starwheel spindle assembly arranged adjacent to the turret assembly, wherein the rotary exit starwheel spindle assembly is configured to receive an integral finished product from the turret assembly;
a first part feeder assembly arranged adjacent to the rotary infeed starwheel spindle assembly and configured to supply the first part to the rotary infeed starwheel spindle assembly; and
a second part feeder assembly arranged adjacent to the rotary infeed starwheel spindle assembly and configured to supply the second part to the rotary infeed starwheel spindle assembly.

19. A method of friction welding separate parts of a plastic component to one another with an apparatus, the apparatus comprising a rotational drive assembly coupled to a turret assembly arranged to be rotationally driven thereby about a longitudinal axis, the turret assembly including a plurality of spindle assemblies disposed circumferentially around the longitudinal axis, each spindle assembly defining a spindle axis and including at least one drive mechanism coupled to a chuck configured to receive and hold a first part of the plastic component, the method comprising:
rotating the turret assembly about the longitudinal axis;
supplying a first part to one of the spindle assemblies on the turret assembly;
supplying a second part to the turret assembly;
moving the chuck of the spindle assembly along the respective spindle axis;
engaging the first part with the chuck;
contacting the first part of the plastic component with a second part of the plastic component; and
moving the chuck and the first part relative to the second part at a speed sufficient to permanently bond the first part to the second part.

20. The method of claim 19, wherein the step of moving the chuck and the first part relative to the second part at a speed sufficient to bond the first part to the second part comprises rotating the chuck and the first part relative to the second part at a rotational speed sufficient to permanently bond the first part to the second part.

21. The method of claim 19, wherein the step of rotating the turret assembly about the longitudinal axis comprises continuously rotating the turret assembly about the longitudinal axis.
